(19) United States
(12) Patent Application Publication
(10) Pub. No.: US 2014/0046675 A1
(43) Pub. Date: Feb. 13, 2014

(54) SYSTEM AND METHOD FOR PROCESSING AND DISPLAYING MEDICAL PROVIDER INFORMATION

(71) Applicants: Jeffrey Harwood, Tarzana, CA (US); Robert Harwood, Woodland Hills, CA (US)

(72) Inventors: Jeffrey Harwood, Tarzana, CA (US); Robert Harwood, Woodland Hills, CA (US)

(21) Appl. No.: 13/570,119

(22) Filed: Aug. 8, 2012

(51) Int. Cl. G06Q 50/22

(52) U.S. Cl. 705/2

(57) ABSTRACT

Systems and methods for displaying medical provider information to patients are provided herein. A system is provided that allows patients to select preference criteria for a medical provider and to receive a list of medical providers matching the preference criteria. Cost information relating to each medical provider may also be provided. A system is also provided that allows a medical provider to enter information into the system for a patient to access, wherein the system presents a fixed cost structure that the medical provider uses in determining medical procedure costs, which are in turn provided to a patient. A method is provided for a patient to access the system and obtain information relating to medical providers, including cost information. A method is also provided for a medical provider to enter information that is accessible to patients and to commit to a fixed cost structure for medical procedures.

### FIELD OF THE INVENTION

The present invention relates to a system in which patients can select medical providers to perform consultations and medical procedures and can also obtain fixed cost information for such consultations and medical procedures.

### BACKGROUND OF THE INVENTION

Patients presently seeking treatment for medical conditions face a high level of variability and unpredictability in determining the cost of treatment, as there is no readily available system for a patient to ascertain medical costs without canvassing a number of medical providers and researching different cost structures for each. This is especially significant in view of the enormous number of patients with no insurance or high insurance deductibles. The cost of an initial consultation, for example, varies among medical providers. Additionally, a patient may meet a medical provider for an initial consultation and then find that such medical provider does not meet the patient's preferences for gender, languages spoken, experience level, and other preferences. However, the patient must still pay for the initial consultation, the cost of which may not even be known until after the consultation is complete.

Following the consultation, once the patient is diagnosed, the patient may face an extensive series of treatment procedures. Commonly, there is little transparency in the realm of medical procedure costs, and patients are commonly not informed as to the costs of the procedures required to treat their condition. For example, patients currently have no “menu” or listing of medical services and procedures with corresponding costs, from which patients can then budget accordingly. Additionally, it would be impossible for a doctor to provide a menu of services because of the large number of possible services and procedures available. This is especially important as many patients enter treatment without knowing what medical procedures will be necessary, or a condition may not be diagnosed until an initial engagement and examination with a medical provider is complete. As a result, a patient may enter into a treatment only to find that the medical expenses become greater than the amount they can afford.

For insured patients, medical provider selection and procedure costs may not be problematic. This is because insured patients are aware of the deductible they must pay, while the remaining costs are generally paid by the insurance provider and are not the responsibility of the patient. Also for this reason, medical providers have not needed to commit to fixed costs for conducting medical procedures, because patients typically do not inquire about such costs when they have sufficient insurance for coverage.

However, in some situations, insured patients may seek a medical provider outside their insured network to perform certain medical procedures. This may occur for several reasons, such as the insured network does not have a medical provider who can perform a necessary procedure, or a patient may find the network provider to be unsatisfactory. In any event, patients seeking medical providers outside their insured network may find themselves either entering the practice of an out-of-network provider without being aware of medical procedure costs, or negotiating prices and “shopping around” with out-of-network providers. Regardless of the situation, patients seeking treatment from out-of-network providers may be faced with a lack of information regarding their treatment and unexpected costs.

On the other hand, for patients with minimal or no insurance or high deductibles, procedure costs are a significant concern. A patient may choose to receive treatment of a severe medical condition, only to enter into a series of unforeseen high payments that quickly become unaffordable. In addition, patients may not have the resources to find medical providers from whom they can receive their required treatments for lower costs. Further, many patients can only find information regarding specialists for treatment by individually consulting general practitioners. For example, for patients who do have some insurance, the insurance provider may only provide general practitioner or internal medicine physicians, without providing any specialist information, which the patient is expected to obtain through referrals. This further limits treatment options for the patient.

On the medical providers' side of the matter, medical providers may be willing to treat uninsured or other similarly-situated patients for lower costs, however, they do not have a way of communicating this with such patients. Also, medical providers may take time to conduct an initial consultation with a patient, only to find that they do not meet that patient's criteria for the type of physician from whom treatment is preferably sought.

To consider another aspect, as opposed to many other fields, competition in the medical field is not driven by cost. In one instance, many insured patients just find medical providers based on their insurance network and pay whatever costs are imposed by their insurance carrier. In another instance, uninsured patients often seek medical providers based on location and word-of-mouth recommendations and proceed unaware of potential costs. In either case, patients are typically not provided information about costs for consultations or medical procedures, such that patients cannot make selections based on what they are required to pay. Also, there is no negotiation in the process of selecting a medical provider and paying for medical treatment.

To remove some of the unpredictability in the medical provider selection process and the treatment process, a medical provider may provide a fixed cost for a procedure based on a predetermined scale, in which various medical procedures each have an associated cost defined to perform that procedure. It may also be preferable to some medical providers to use such a scale as a basis in determining the cost to perform a procedure while modifying such cost by a selected conversion factor to increase or decrease the cost in a manner that best suits the medical provider. In another instance, medical providers may choose their own costs for medical procedures as needed, in order to assist patients whose funds would not otherwise meet standard rates. In committing to performing services at fixed costs, the medical provider may be able to provide services to more patients who are seeking a predictable cost structure for treatment, in addition to providing lower rates that are not defined by insurance networks.

For these reasons, it is desirable to have a system that allows patients to obtain information regarding medical providers and treatment procedure costs and to have a system that allows for medical providers to provide fixed costs at which they may conduct treatment procedures.

### SUMMARY OF THE INVENTION

In accordance with one aspect of the present invention, a system providing for medical provider information to a patient is provided. The system includes a patient input interface configured to be presented on an electronic display and a database comprising a list of medical providers and medical provider data for each of the medical providers. The system also includes a processor configured to communicate with the patient input interface and with the database to compare preference criteria of the patient with the medical provider data and to generate a results list of potential medical providers with medical provider information matching the preference criteria of the patient. The system further includes a results display configured to be presented on the patient input interface that displays the results list of potential medical providers and a cost of a consultation for each of the potential medical providers.

In accordance with a second aspect of the present invention, a system is provided for storing and displaying medical procedure costs. The system includes a database stored on a server, wherein the database includes a list of medical procedures, a list of medical providers associated with the list of medical procedures in a manner that identifies each of the medical providers that performs each of the medical procedures, and a fixed cost for each identified medical provider to perform each of the respective medical procedures. The system also includes an interface configured to receive a request for the fixed cost for at least one of the identified medical providers to perform at least one of the respective medical procedures. The system further includes a processor that communicates with the interface and is configured to process the request for the fixed cost and to communicate with the database to obtain data responsive to the request for the fixed cost, and is further configured to communicate the data to the interface for display on the interface.

In one embodiment, the database also includes a Relative Value Scale that assigns a cost to each of the medical procedures in the list of medical procedures. In another embodiment, the fixed cost for each identified medical provider to perform each of the respective medical procedures is based on the Relative Value Scale. In a further embodiment, the fixed cost for each identified medical provider to perform each of the respective medical procedures is based on the Relative Value Scale in combination with one or more conversion factors.

In a third aspect of the present invention, a method for a patient to obtain information relating to one or more potential medical providers is provided. The method includes accessing a system comprising a list of medical providers each having corresponding medical provider data, receiving preference categories from the system from which to select preference criteria for a medical provider, and submitting a request to the system for medical providers that match the preference criteria. The method also includes receiving a results display from the system that features a results list comprising potential medical providers from the list of medical providers, wherein the preference criteria at least partially matches the corresponding medical provider data for each of the respective medical providers. In one embodiment, the results display shows the cost of a consultation for each of the potential medical providers. In another embodiment, the method includes submitting a price range to the system for a consultation with a medical provider, and submitting a request to identify medical providers from the list of medical providers who charge a price within the price range for a consultation.

Other and further aspects and features of the invention will be evident from reading the following detailed description of the preferred embodiments, which are intended to illustrate, not limit, the invention.

### BRIEF DESCRIPTION OF THE DRAWINGS

The drawings illustrate the design and utility of preferred embodiments of the present invention, in which similar elements are referred to by common reference numerals. In order to better appreciate how the above-recited and other advantages and objects of the present inventions are obtained, a more particular description of the present inventions briefly described above will be rendered by reference to specific embodiments thereof, which are illustrated in the accompanying drawings. Understanding that these drawings depict only typical embodiments of the invention and are not therefore to be considered limiting of its scope, the invention will be described and explained with additional specificity and detail through the use of the accompanying drawings in which:

FIG. 1 is a diagram view of one embodiment of a system for providing medical provider data to a patient;

FIG. 2 is a diagram view of an embodiment of a patient input interface associated with the system of FIG. 1;

FIG. 3 is a diagram view of an embodiment of a medical provider input interface associated with the system of FIG. 1;

FIG. 4 is a flowchart illustrating one embodiment of a method of operating the system of FIG. 1 for a patient;

FIG. 5 is a flowchart illustrating one embodiment of a method of operating the system of FIG. 1 for a medical provider;

FIG. 6 is a flowchart illustrating one embodiment of a method for a patient to use the system of FIG. 1; and

FIG. 7 is a flowchart illustrating one embodiment of a method for a medical provider to use the system of FIG. 1.

### DETAILED DESCRIPTION OF THE EMBODIMENTS

The description that follows relates to a system that allows for input and interaction between patients and medical providers and that maintains and presents information about specific medical providers and costs for consultations and medical procedures. The medical providers to whom the system may apply include practitioners in all manner of fields that provide services to patients, including general practitioners, medical specialists, dentists, chiropractors, podiatrists, therapists, alternative and natural medical practitioners, and others. A patient may use the system to research medical providers and to submit medical provider preferences, as will be described in further detail below. In some instances, a patient may want to use the system to establish a relationship with a family physician or other general practitioner for annual exams and wellness checks. In other instances, a patient may want to use the system to address a medical condition of concern, for which the patient seeks treatment. In this situation, the patient may initially use the system to seek a medical provider who is a general practitioner in order to obtain a diagnosis for the medical condition. Afterward, the patient may then use the system to find a specialist to provide the necessary medical procedure for treatment of the diagnosed condition. Medical providers may likewise use the system to make their practice information available to a wider body of patients and to adjust their costs to meet potential patient needs.

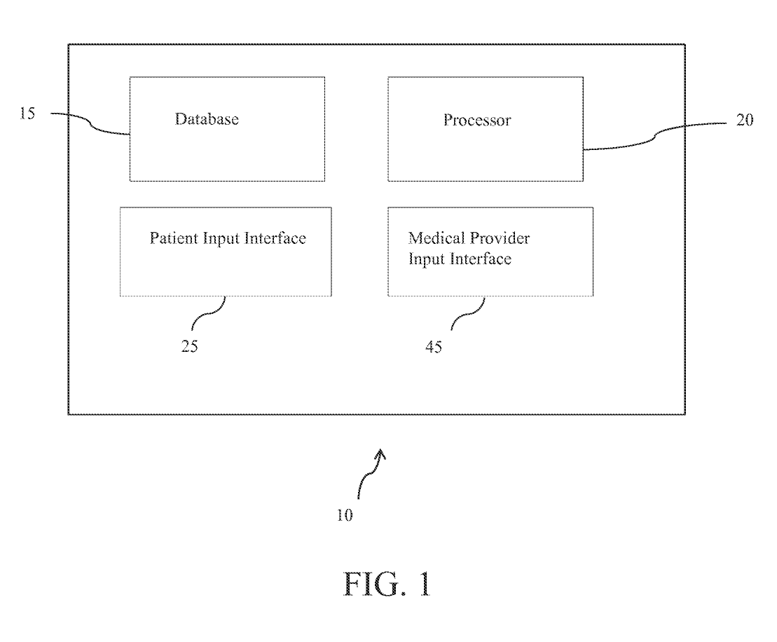

Turning first to FIG. 1, an exemplary medical provider data system 10 is shown. In one embodiment, the system 10 includes a database 15 that stores a list of medical providers and medical provider data for each of the medical providers. One part of the medical provider data includes the field and/or specialty in which each medical provider practices, such as: general practice; family medicine; specialties, such as obstetrics, cardiology, neurology, and others; chiropractic; podiatry; therapy, including physical and psychological therapy; natural or alternative medicine, including acupuncture, herbals, reflexology, etc.; and a wide variety of others. The medical provider data may also include other information relating to each medical provider, for example: gender; ethnicity; office location; contact information (e.g., phone number, e-mail, fax); year of medical school graduation; years in practice; board certification; fellowships; academic appointments; languages spoken; third-party ratings and recommendations; hospital and/or clinic affiliations; personal interests; age; insurance carriers; and others. In one embodiment, the medical provider data also includes the cost of a consultation with each medical provider and/or the cost of specific procedures performed by each medical provider, which will be explained in further detail below.

The system also includes a processor 20 that is configured to receive, send, and process requests sent to and from patients and medical providers. The processor 20 communicates with the database 15 to process such requests and other information associated with the system 10.

The system 10 additionally features a patient input interface (PII) 25 that the system 10 presents to a patient user so the patient can interact with the system 10. For example, the PII 25 allows a patient to access and use the system 10 to retrieve and view information relating to various medical providers having medical provider data stored in the database 15. The system 10 presents the PII 25 on an electronic display, and the PII 25 may be accessed on-line through a computer, a mobile device such as a cellphone or electronic tablet, a television, or other Internet-accessible device.

In one embodiment, in order to allow a patient to use the system 10, the system 10 is configured to require the patient to create a patient account with the system 10 through the PII 25. The patient account may include a log-in identification and password that permits a patient to securely access the system 10. In creating the patient account, the system 10 may request that the patient enter specific personal information through the PII 25 to form a patient profile associated with the patient account. By having patient users create patient accounts, the system 10 can maintain a record of patient transactions and information associated with each patient account, including preferences for medical providers, searches completed for medical providers, personal information, and a variety of other applicable information, all of which may make the system 10 more user-friendly for the patient. Such patient information that is recorded through the patient accounts may be stored in the database 15.

In one embodiment, as a prerequisite to using the system 10 and/or creating a patient account, the system 10 is configured to require each patient to agree to terms and conditions of use. Such terms and conditions may require the patient to agree not to hold an administrator of the system 10 responsible for any inaccurate information provided by the system 10, and to enter patient information as accurately as possible. In another embodiment, the system 10 is configured to require the patient to grant authority to an administrator of the system 10 to access the patient's medical history from previous and/or current medical providers of the patient. This may eliminate the step of having medical providers who agree to see patients through the system 10 from having to separately obtain authorization to request medical histories from each patient. In another embodiment, the system 10 is configured to require the patient to complete a medical history form that may be accessed by potential medical providers who are considering working with the patient. In another embodiment, the system 10 is configured to require the patient to pay a fee for using the system 10. This may be an introductory fee and/or a time-based fee, such as a monthly, quarterly, or annual fee. The system 10 may also be configured to allow a patient a free trial period, in which the system 10 may provide all available features to the patient, or only limited features tailored to trial use.

After a patient is given access to the system 10, the system 10 is configured to present the PII 25 to the patient to allow the patient to begin using the system 10. The PII 25 is configured to allow a patient to submit a request for information relating to medical providers through a format in which a patient can input preferences for a medical provider. In one embodiment, the PII 25 displays a series of preference categories relating to medical providers, from which a patient can select preference criteria for a medical provider that suits the patient's needs. The preference categories for medical providers may include, as examples: office location and/or distance from a patient's specified location (e.g., a zip code or home address); languages spoken; gender; ethnicity; board certification status; medical specialty; patient ratings; office or clinic details; insurance carriers; years in practice; medical school; undergraduate school; degrees completed; and other criteria. The PII 25 may be configured to display the preference categories to the patient in any variety of formats from which the patient can make selections for preference criteria, such as: a question-by-question format; a drop-down window for each preference category; a large screen showing all preference categories; and other manners of display. In one embodiment, the PII 25 is configured to present the preference categories in association with a scale of priorities. For example, the PII 25 may allow a patient to select preference criteria with gender and years in practice as high priority items, and languages spoken and medical school attended as low priority items.

The system 10 is configured to receive a request from a patient for information relating to medical providers with the patient's selected preference criteria through the PII 25, wherein the preference criteria is communicated to and processed by the processor 20 and further communicated to and stored in the database 15. In one embodiment, a patient's preference criteria selections are stored with the corresponding patient account information in the database 15. The processor 20 is programmed to communicate with the database 15 to compare the patient's selected preference criteria with the medical provider data stored in the database 15 to find matches for the patient, i.e., medical providers with medical provider data matching that of the selected preference criteria of the patient. For example, if the PII 25 received a request from a patient for a medical provider with preference criteria including female, fluent in Spanish, and board-certified, the processor 20 would find medical providers in the database 15 with medical provider data matching those items.

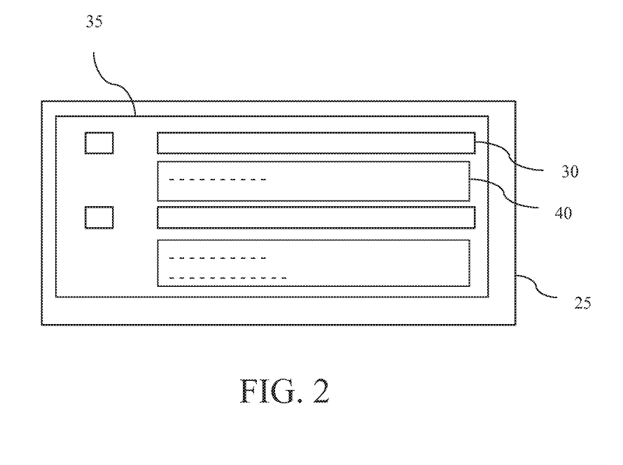

Referring now to FIG. 2, the processor 20 is further programmed to generate a results list 30 of medical providers with medical provider data matching a patient's selected preference criteria. The results list 30 provides the patient with potential medical providers whom the patient may choose to see for a consultation or a medical procedure, depending on the patient's needs and the stage of the patient's treatment. In one embodiment, the results list 30 provides the names of the medical providers meeting the patient's preference criteria. In another embodiment, the results list 30 does not initially provide the names of the medical providers on the list 30. Rather, the PII 25 requires the patient to make a selection for a medical provider that the patient wishes to see before providing the name of that medical provider. In this manner, the results list 30 focuses the patient on the preference criteria.

The processor 20 may be programmed to only include medical providers on the results list 30 who meet all of a patient's preference criteria, or the processor 20 may be programmed to include medical providers who meet at least a certain percentage of a patient's preference criteria, for example, 50% or more. In the embodiment in which a patient is provided with a scale of priorities in selecting preference criteria, the processor 20 may be programmed to include medical providers on the results list 30 that meet all of the preference criteria that are high-priority items, and only 50% of the preference criteria that are low-priority items.

The processor 20 is programmed to communicate with the PII 25 to provide a results display 35 on the PII 25 with the results list 30. The results display 35 shows the results list 30 from which a patient can review and select medical providers. In one embodiment, the system 10 is configured to allow the patient to modify or narrow the results list 30 through the PII 25, and in particular, through the results display 35. For example, if a results list 30 includes over 100 medical providers, the results display 35 may provide the patient who requested the results list 30 with the option to edit the preference criteria, such that a smaller results list 30 is generated, or to display the results list 30 in a manner that is readily viewable, such as 10 medical providers per display page. The PII 25 may allow the patient to modify preference criteria as much as desired, such that the processor 15 may generate an unlimited number of results lists 30 for the patient. In one embodiment, the PII 25 is configured to provide a patient with the option to save results lists 30 for later access. For example, the PII 25 may present a patient with the option to store a results list 30 with her patient account and to identify the list for future review, e.g., “Family Doctor List—June 1.”

The PII 25 may also be configured to present each results list 30 with various formats of information for each medical provider on the results list. For example, a results list 30 may include a formatted results display 35 such that for each medical provider on the results list 30, the results display 35 shows the preference criteria that the medical provider meets along with a general profile 40 of the medical provider. The general profile 40 is created in the system 10 and may include information from the medical provider data in the database 15, for example, office location and contact information, medical school, personal interests, and years in practice, along with any other information that is suitable to display to the patient for providing general information about a medical provider. Information presented in the general profile 40 is communicated by the database 15, as it is stored therein for each medical provider, to the PII 25.

The results display 35 may also be configured to show the cost of a consultation with each medical provider in the results list 30. In one embodiment, the cost of a consultation for each medical provider is stored in the database 15, such that whenever a medical provider is selected as a match for the patient's preference criteria, the results display 35 will show the cost of a consultation with that medical provider, in addition to the general profile 40 and matching preference criteria for that medical provider. In this manner, the patient can make a determination as to which medical provider best suits the patient based on cost as well as the preference criteria. Thus, the patient is readily informed in selecting a particular medical provider, such that the patient does not have to wait until after a consultation with a medical provider to be aware of the costs.

In one embodiment, the PII 25 is further configured to allow patients to request appointments with a selected medical provider, particularly a medical provider selected from a results list 30 generated for a patient. As an example, the PII 25 may be configured to allow a patient to select a medical provider from a results list 30 that is generated based on the patient's preference criteria. Upon receiving a selected medical provider from the patient, the PII 25 provides the patient with an option to request an appointment with the medical provider, e.g., by displaying an inquiry window or an instruction block. If the patient chooses to request an appointment, the PII 25 is configured to send an appointment request to the processor 20, which is in turn programmed to send the appointment request to the selected medical provider. In one embodiment, the system 10 sends the appointment request to the selected medical provider via e-mail. The medical provider may establish communication protocols with the system 10 wherein appointment requests are sent to an e-mail address for staff that handles appointment schedules. In response to sending the appointment request to the selected medical provider, the system 10 may also be configured to receive appointment scheduling options from the selected medical provider, for example via e-mail, which the system 10 in turn sends to the requesting patient through the PII 25. The system 10 may be configured to facilitate further appointment communications between the patient and the selected medical provider, such that the system 10 may conduct and facilitate the entire appointment scheduling process.

In another embodiment, in addition or as an alternative to allowing a patient to submit preference criteria in order to view potential medical providers, the PII 25 may be configured to receive a request from a patient to view information relating to a particular medical provider, such as the general profile 40 of a medical provider. For example, the PII 25 may provide an option to the patient to display a medical provider request window in which a patient can enter the name of a known medical provider, and if possible, the city and state where the medical provider practices. The processor 20 receives the request from the PII 25 and communicates with the database 15 to obtain the medical provider data, including the general profile 40, for that particular medical provider. The processor 20 is programmed to return the general profile 40 of the medical provider and any other information selected by the system 10 to the PII 25 for display to the patient.

In order for medical providers to be included in the list of medical providers in the database 15 and have their information available to patient users of the system 10, the system 10 also has an interface for medical providers that allows medical providers to use the system 10 and enter and edit medical provider information. Initially, in order for medical providers to be included in the database 15, an administrator of the system 10 may send invitations or requests to various medical providers to submit their medical provider information to the system 10. Alternatively, medical providers may send requests to an administrator of the system 10 to enter their medical provider information into the system 10. In one embodiment, the administrator may review the credentials of each medical provider that wishes to have his/her medical provider information added to the system 10, and additionally compare the information submitted by each medical provider to information that is publicly available. For example, each medical provider may be checked for board certification, educational background, practice history including complaints or recommendations, and state compliance records. In another embodiment, the medical provider information for each medical provider is not reviewed by anyone administering the system 10 but is instead verified at will by the patient selecting each medical provider.

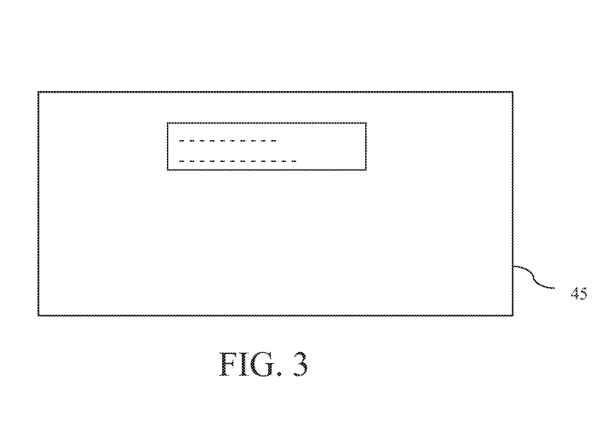

Referring to FIG. 3, the system 10 features a medical provider input interface (MPII) 45 that is presented to a medical provider so the medical provider can interact with the system 10, for example, to access and use the system 10 through the MPII 45 to maintain her medical provider information in the database and/or interact with potential patients and respond to potential patient requests. Similar to the PII 25, the MPII 45 is presented on an electronic display and may be accessed on-line through a computer, a mobile device such as a cellphone or electronic tablet, a television, or other Internet-accessible device.

In one embodiment, the system 10 is configured to require a medical provider to create a medical provider user account through the MPII 45 in order to allow the medical provider to use the system 10. The medical provider user account may include a log-in identification and password that permits a medical provider to securely access the system 10. The MPII 45 communicates with the database 15, such that the database 15 receives and stores medical provider information entered through the MPII 45 for each medical provider. The medical provider information entered by each medical provider through the MPII 45 is stored as medical provider data 15 in the database 15. The database 15 communicates with the processor 20, such that the processor 20 can access the medical provider data in the database 15 to match patient preference criteria with medical providers. In an alternative embodiment, a medical provider submits medical provider information to the system 10 through direct communications with a system administrator, such as over the phone or through e-mail.

In one embodiment, the system 10 is configured to require each medical provider to agree to various terms and conditions as a prerequisite to being included in the list of medical providers in the database 15. Such terms and conditions may require that each medical provider who uses the system 10 agrees, to the greatest extent possible, to disclose all information requested by the system 10 and to keep all certification and practice information current. Other terms may require that each medical provider who uses the system 10 agrees to commit to a fixed cost structure in providing consultations and performing medical procedures, which will be described in greater detail below.

The medical provider user account allows a medical provider to securely access the system 10 through the MPII 45. In one embodiment, the system 10 requests that a medical provider enter specific medical provider information through the MPII 45 to form a medical provider profile with corresponding medical provider data that is stored in the database 15. The medical provider information requested by the system 10 may include the items listed above, namely: the field and/or specialty in which each medical provider practices; gender; ethnicity; office location; contact information (e.g., phone number, e-mail, fax); year of medical school graduation; years in practice; board certification; fellowships; academic appointments; languages spoken; third-party ratings and recommendations; hospital and/or clinic affiliations; personal interests; age; insurance carriers; and others. Additional information requested by the system 10 that relates to the practice status of a medical provider may include: medical license number; years remaining on medical license; last date of medical license renewal; and others. The system 10 may be configured such that only certain information is available for patients to view. For example, the system 10 may not permit a patient to view the medical license number of a medical provider. However, the system 10 may retain this information to identify the medical provider within the system 10.

In another embodiment, the system 10 may also be configured to allow a medical provider to enter patient preferences with her medical provider information. For example, a medical provider may have the option to enter preferences for particular patients, such as patients who live within 30 miles of their office or who speak Spanish and/or English. The system 10 may note such preferences for each medical provider on the results lists 30 that the system 10 generates for patients. Likewise, the medical provider may have the option to enter patient exclusions that are acceptable under applicable laws and practice requirements, so that a medical provider is not featured on results lists 30 for certain patients, or so that such exclusions may be shown for each medical provider on results lists 30 that the system 10 generates for patients. As examples, such exclusions may be based on address (e.g., patients who live more than 50 miles away), age (a pediatrician may only want to see children age 18 or younger), a full patient roster, wherein the medical provider is not currently taking new patients, and so on. This helps to optimize matches between patients and medical providers, such that a patient has more information to select a medical provider that is better suited to the patient, and medical providers can inform potential patients about specific aspects of their practice.

The system 10 may also be configured to require each medical provider to submit fixed costs for initial consultations and medical procedures. In this way, the system 10 can provide patients with cost information relating to each medical provider. In one embodiment, each medical provider that has a medical provider user account with the system 10 must agree to a set cost structure for consultations and medical procedures. In one embodiment, the agreement of each medical provider to commit to a fixed cost for procedures and consultations is verified in the form of a contract, which the system 10 may provide electronically to each medical provider. The costs to which each medical provider agrees become part of the medical provider data for that medical provider.

In setting the fixed cost structure, in one embodiment, the system 10 includes a list of medical procedures, which may include consultations, and a predetermined scale that assigns a fixed cost to each medical procedure in the list of medical procedures. The list of medical procedures and the scale may be stored in and accessed from the database 15.

As a condition to using the system 10, the system 10 may require each medical provider to use the scale as a basis in determining fixed costs for consultations and procedures, which the medical providers may optionally adjust with conversion factors, as will be discussed in further detail below. The costs assigned for each medical procedure in the scale may be based on pre-existing data, such as an average of costs from a survey of insurance providers, Medicare, or Medicaid costs. In one embodiment, the system 10 uses a Relative Value Scale (RVS) similar to that used by Medicare. Alternatively, the costs assigned for each medical procedure in the RVS may be based on an original cost schedule authored by a party associated with the system 10. Regardless of the type of scale used, the system 10 is configured to allow for revisions to the scale, such that the scale may be dynamic to accommodate cost fluctuations in the medical field. For purposes of illustration only, embodiments using a version of the RVS for the scale will be described.

As an illustration of applying the list of medical procedures and the RVS, the list of medical procedures may include: an initial consultation with a pediatrician, to which the RVS assigns a cost of $50; a suture procedure requiring 10 stitches or less, to which the RVS assigns a cost of $700; and the examination and setting of a fractured arm bone, to which the RVS assigns a cost of $2,000; and so on. In another embodiment, the system 10 modifies the costs listed in the RVS by taking factors into account that may affect costs of a procedure, such as the geographic location where a medical provider performs a procedure, whether procedures are to be performed in a hospital or clinic, age of the patients on whom the services are performed, and so on.

The system 10 is configured to provide each medical provider with access to the costs assigned by the RVS through the medical provider user account for each medical provider, particularly through the MPII 45. This allows the medical providers to review the baseline costs of consultations and medical procedures that they perform as assigned by the RVS. In one embodiment, the list of medical procedures and corresponding costs assigned in the RVS may be viewed as an entire list. In another embodiment, each medical procedure is assigned an alpha-numeric code which can be entered by the medical provider to look up a particular medical procedure in the list of medical procedures and to view the corresponding cost assigned by the RVS. The code may be based on a standardized system such as the Current Procedural Terminology (CPT) authored by the American Medical Association, or it may be a series of codes authored by a party associated with the system 10. The codes assigned to each medical procedure may be available in a reference index provided by the system 10 to the medical provider users. In another embodiment, a medical procedure title is entered to look up the medical procedure, and/or medical procedures with similar terms, along with the cost assigned to the medical procedure by the RVS.

In one embodiment, they system 10 allows medical providers to modify the costs to which they commit for conducting consultations and performing medical procedures. For example, a medical provider may agree to charge the cost amounts assigned by the RVS. In another example, a medical provider may agree to charge costs equal to the RVS multiplied by a conversion factor. As an illustration, the medical provider may agree to charge the cost amount assigned by the RVS multiplied by a conversion factor of 1.20 (or 120%) for all medical procedures. In another example, the medical provider may agree to charge the cost amount assigned by the RVS multiplied by 0.80 (or 80%). In yet another embodiment, the medical provider may apply different conversion factors to certain medical procedures. For example, a medical provider may agree to charge the cost amount assigned by the RVS for medical procedures classified as out-patient services, and may also agree to charge the cost amount assigned by the RVS multiplied by a conversion factor 1.30 (or 130%) for medical procedures classified as in-patient services. The conversion factor specified by a medical provider is received through the MPII 45 and stored in the database 15 as part of the medical provider data for each respective medical provider.

In an additional embodiment, medical procedures and consultations are treated separately, such that the RVS only provides costs for medical procedures but not for consultations. As such, the cost of a consultation is completely at the discretion of the medical providers, while costs for medical procedures are based on the RVS and any conversion factors applied by the medical providers. In this manner, medical providers may commit to costs for consultations at greatly reduced rates, or even on a complimentary basis. Such consultation costs selected by the medical providers are received in the system 10 through the MPII 45 and stored in the database 15 with the respective medical provider data.

In another embodiment, the system 10 allows medical providers to submit their own cost structures, rather than basing their costs on the RVS. For example, a medical provider may set his own costs for a consultation and any other procedure he performs. The system 10 would receive the medical provider's costs for medical procedures and store such costs with the medical provider data for that medical provider.

Because patients will typically not know what medical procedures will be required for their treatment, in one embodiment, the only cost information that the system 10 provides to patients, particularly in response to requests submitted through the PII 25, is that of a consultation. Additional costs for medical procedures may be provided to the patient by a medical provider during a consultation with the patient. In such case, the system 10 confirms costs of a medical procedure to the medical provider through the MPII 45, after which the medical provider shares such medical procedure cost information with the patient. In an alternative embodiment, the system 10 may allow patients to access cost information in the RVS for specific medical procedures and/or for specific medical providers, or the system 10 may provide cost ranges for medical procedures based on information in the database 15. It is expected that a patient would not be aware of codes associated with medical procedures, as in the embodiment in which alpha-numeric codes are assigned to each procedure. As such, the system 10 may provide general categories of procedures from which the patient can obtain cost information.

As medical care costs are always fluctuating and circumstances for medical providers in conducting their practice are constantly variable, it may not always be reasonable for a medical provider to commit to a fixed cost for a consultation or medical procedure for an extended period of time. As such, in one embodiment, when the system 10 provides a patient with the cost of a consultation with a medical provider, the system 10 submits a statement to the patient through the PII 25 that the cost provided is only effective for a set period of time, e.g., 30 days. Also, when a medical provider provides a patient with the cost of a medical procedure, as committed to in the medical provider user account, the medical provider may inform the patient that the cost provided is only effective for a set period of time, as determined by the system 10 and/or the medical provider.

The system 10 also allows medical providers to modify their medical provider information that is stored with the corresponding medical provider data in the database 15. For example, medical providers may change their addresses, obtain updated board certification, or change status as to whether they are available to see new patients. As such, the MPII 45 is configured to allow medical providers to edit their medical provider information, wherein any medical provider information modifications received through the MPII 45 are stored with the medical provider data in the database 15. Each medical provider may also change his/her cost agreements. For example, a medical provider may have previously agreed to charge the cost amount assigned by the RVS multiplied by 1.05 but may later wish to change the multiplier to 0.95. The MPII 45 is configured to allow the medical provider to change the multiplier, wherein any such multiplier modifications received through the MPII 45 are stored with the medical provider data in the database 15. With each such change to the multiplier, the system 10 may additionally require the medical provider to re-enter into the agreement to abide by the new cost amounts. The system 10 may also limit the changes that each medical provider makes to cost multiplier over a selected time period.

In an alternative embodiment, the system 10 allows medical providers to offer adjusted costs for a consultation or medical procedure on a real-time basis. For example, in one embodiment, the system 10 may be configured to allow a patient to enter a request for medical providers matching the patient's preference criteria and a price range within which the patient is willing to pay for a consultation with a medical provider. This request for medical providers meeting a specified price range is received through the PII 25, processed by the processor 20, and communicated to the database 15 to generate a results list 30 for medical providers matching the preference criteria. The system 10 is also configured to send a cost request to one or more of the medical providers on the generated results list 30, wherein the request may be based on a selection by the system 10 or the patient. If the medical providers can meet the patient's price range for a consultation, the system 10 is configured to receive responses from the medical providers with the costs that they will agree to accept.

In another embodiment, the system 10 may allow a patient to enter a request for medical providers matching the patient's preference criteria and then generate a results list 30 in response to the request. The system 10 may then allow the patient to send a request for a cost of a consultation to medical providers that the patient selects from the results list 30. This request is received through the PII 25 and processed by the processor 20, wherein the processor 20 sends the cost request to the selected medical providers. The system 10 is also configured to receive responses with cost data for a consultation from the selected medical providers. This provides for an open-ended cost-setting process in which patients have a range of costs for selection, and medical providers likewise are allowed to be flexible in pricing. The above embodiments for medical providers setting costs in real-time for consultations may also apply to medical providers setting costs in real-time for medical procedures.

As the system 10 allows patients to request specific costs or submit open-ended cost requests, and further allows medical providers to alter their costs to meet patient needs, the patient may select from a range of costs from medical providers that closely suits their payment capabilities. Likewise, medical providers have the opportunity to see a patient with whom they may not have had to opportunity to be matched by permitting flexibility in the cost structure of their practice. Overall, as the system 10 allows for medical providers to provide definitive costs to patients, the system 10 brings certainty to patients regarding costs they will pay for consultations and medical procedures. In addition, the system 10 brings together medical providers and patients who may not have otherwise had access to each other.

Having described various configurations of the medical provider data system 10, methods of operating and using the system 10 will now be described. To first provide general points, in most situations, a patient will be aware of when an initial consultation is needed with a medical provider, but may not be aware of the medical procedures that will be needed to treat a condition of the patient. Rather, any necessary medical procedures for the patient may not be determined until a patient consults with a medical provider, after which the medical provider diagnoses a condition of the patient and determines any medical procedures that may be required. Typically, it would not be recommended for a patient to undergo self-diagnosis without consulting a medical provider. In this manner, when a patient seeks a consultation with a medical provider, the patient may use the system 10 to quickly find a medical provider who meets the preference criteria of the patient. The patient will also be able to determine the cost of a consultation with the medical provider.

If a medical provider that a patient selects from the system 10 meets with the patient and makes a cursory diagnosis, for which a specialist may be needed for further consultation, the medical provider may provide one or more specialist referrals to the patient. The patient may then refer back to the system 10 to access the medical provider information for the referred specialists. Additionally, so the patient is not limited in making a specialist selection, the patient may also conduct her own search for other specialists that meet the patient's preference criteria. The patient will also be able to access the cost of a consultation for each specialist, in order to help the patient choose which specialist to see. When the patient has the consultation with the specialist, the specialist can then make a more definitive diagnosis. In addition, the specialist can access the required medical procedures necessary to treat the patient in the system 10 and inform the patient of the costs of each procedure based on the RVS. As such, the patient is continuously provided with access to medical providers through the system 10 and may receive definitive cost information for proceeding with treatment. Likewise, medical providers may be able to treat patients who are a good fit with their practice and provide them with helpful cost information that increases customer satisfaction and may further streamline the treatment process.

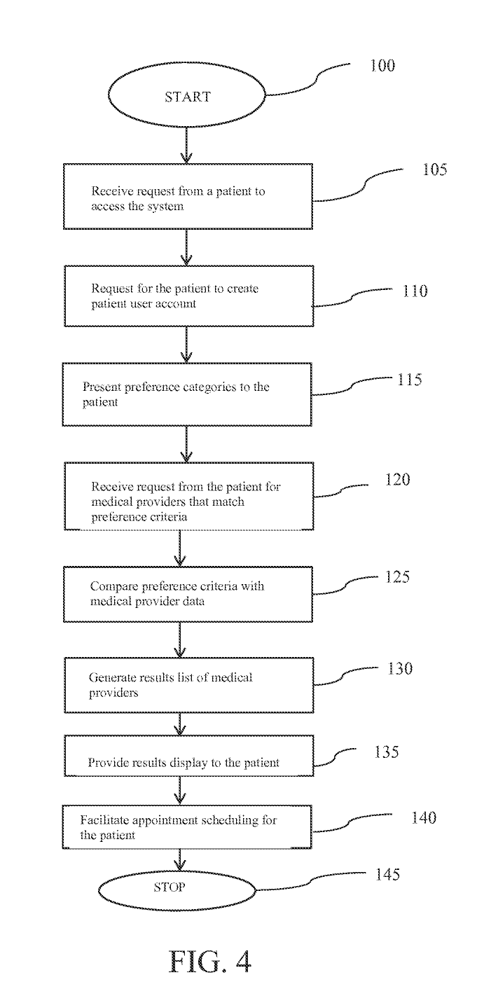

Now referring to FIG. 4, a method of operating the system 10 for a patient will now be described. The operation process for a patient starts at step 100. The system 100 receives a request from a patient to access the system (step 105) and requests that the patient create a patient user account (step 110). In one embodiment, the request is made pursuant to terms and conditions of the system 10. The system 10 then presents preference categories to the patient through the PII 25 from which the patient may select preference criteria for potential medical providers (step 115). The system 10 receives a request for medical providers that match the patient's preference criteria, which is processed by the processor 20 and communicated to the database 15 (step 120). The processor 20 communicates with the database 15 to compare the patient's selected preference criteria with the medical provider data stored in the database 15 to find matches for the patient (step 125). Upon finding matches, the processor 20 generates a results list 30 of medical providers with medical provider data matching a patient's selected preference criteria (step 130). The processor 20 then communicates with the PII 25 to provide a results display 35 on the PII 25 with the results list 30 (step 135). In one embodiment, the processor 20 is programmed to provide consultation and/or medical procedure cost information for each medical provider on the results list 30. The system 10 may further facilitate appointment scheduling between the patient and a medical provider on the results list 30 (step 140). The process ends at step 145.

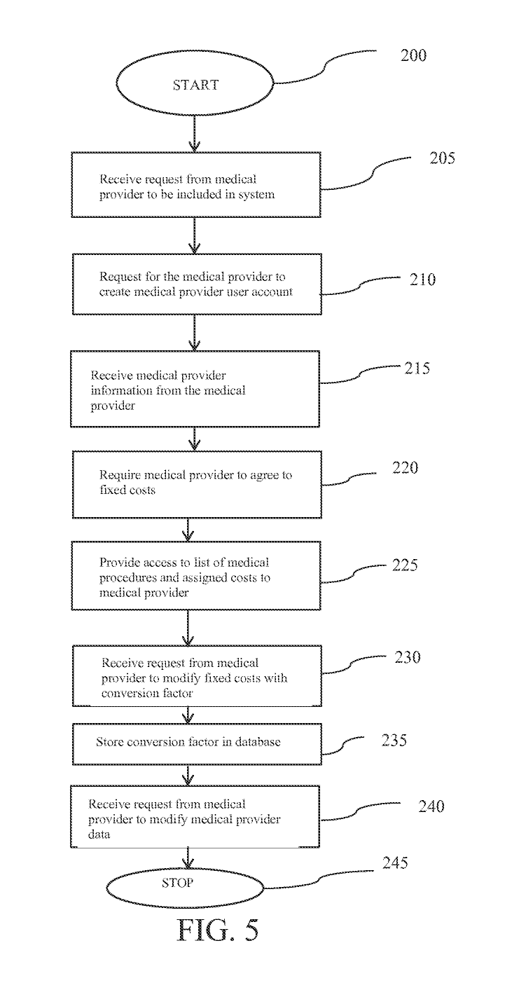

Referring to FIG. 5, a method of operating the system 10 for a medical provider will now be described. The operation process for a patient starts at step 200. The system 10 receives a request from a medical provider to be included in the list of medical providers in the system 10 (step 205). Alternatively, the system 10 may send a request to a medical provider to be included in the list of medical providers in the system 10. The system 10 presents a MPII 45 to the medical provider and requires the medical provider to create a medical provider user account through the MPII 45 (step 210). In one embodiment, the request is made pursuant to terms and conditions of the system 10. The system 10 receives medical provider information from the medical provider through the MPII 45 that is stored in the database 15 with the medical provider data to create a medical provider profile (step 215). The system 10 also requires the medical provider to agree to fixed costs for performing consultations and medical procedures based on the RVS (step 220). The system 10 provides access to the list of medical procedures and corresponding costs assigned to each procedure by the RVS through the MPII 45 (step 225). The system 10 also receives a request from the medical provider through the MPII 45 to modify the fixed costs for that medical provider based on a conversion factor set by the medical provider (step 230). The system 10 stores the conversion factor in the database 15 with the medical provider data for that medical provider (step 235). The system 10 may later receive a request from a medical provider to modify the medical provider data in the database 15 for that medical provider, for which the system 10 receives updated information for the medical provider through the MPII 45 and stores the updated information in the database 15 (step 240). The process ends at step 245.

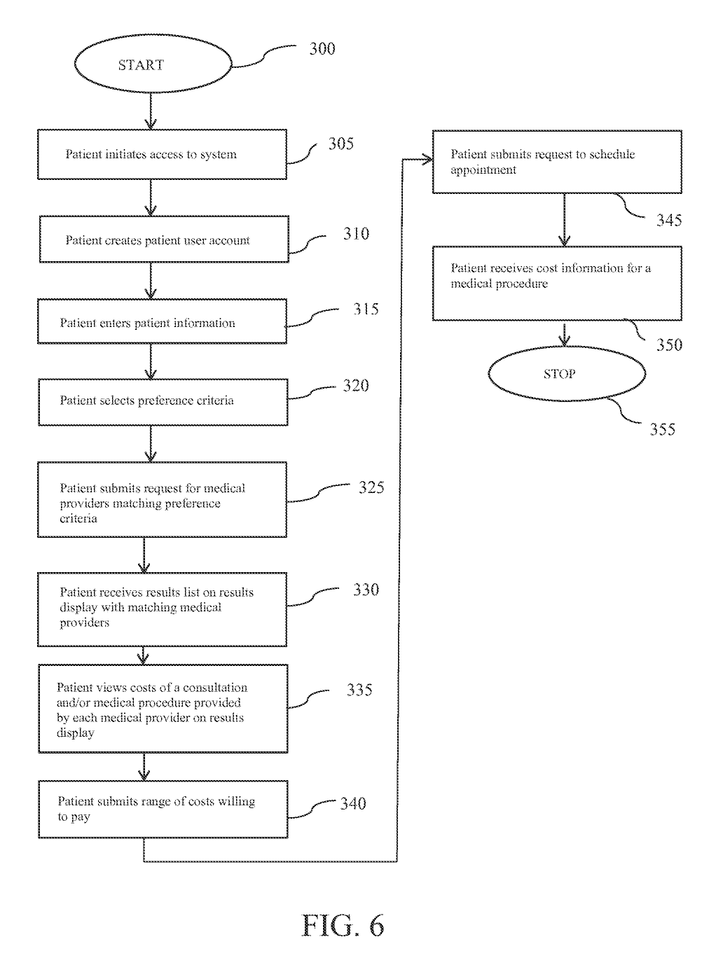

Referring to FIG. 6, a method for a patient to use the system 10 will now be described. The patient process starts at step 300. A patient initiates access to the system 10 through the PII 25 (step 305) and creates a patient user account (step 310) for which the patient may be required to agree to terms and conditions of the system 10. The patient enters patient information through the PII 25 that is stored in the database 25 as part of the patient user account (step 315). Afterward, the patient may search for medical providers to meet for a consultation or to perform a medical procedure. This may be done by selecting preference criteria from a variety of preference categories presented on the PII 25 (step 320). The patient submits a request for medical providers who meet the patient's preference criteria through the PII 25 (step 325). Next, the patient receives the results list 30 from the system 10 with medical providers matching the patient's preference criteria on a results display 35 presented on the PII 25 (step 330). The patient can view the medical providers on the results list 30 to determine one or more medical providers best suited to the patient. The patient may also view the cost of a consultation and/or a medical procedure provided by each medical provider on the results display 35 (step 335). In one embodiment, the patient may submit a range of costs for a consultation and/or a medical procedure through the PII 25 that the patient is willing to pay for submission to medical providers in the system 10, so the patient may verify if any medical providers can meet the patient's cost range (step 340). In one embodiment, the patient may also submit a request to a selected medical provider to schedule an appointment (step 345). This may be done for a consultation to meet with the medical or for a medical procedure to be performed by the medical provider. When a patient meets with a selected medical provider, the patient may also request the cost of a medical procedure that the medical provider recommends to be performed, wherein the patient receives the requested cost information from the medical provider as agreed upon by the medical provider through the system 10 (step 350). The process ends at step 355.

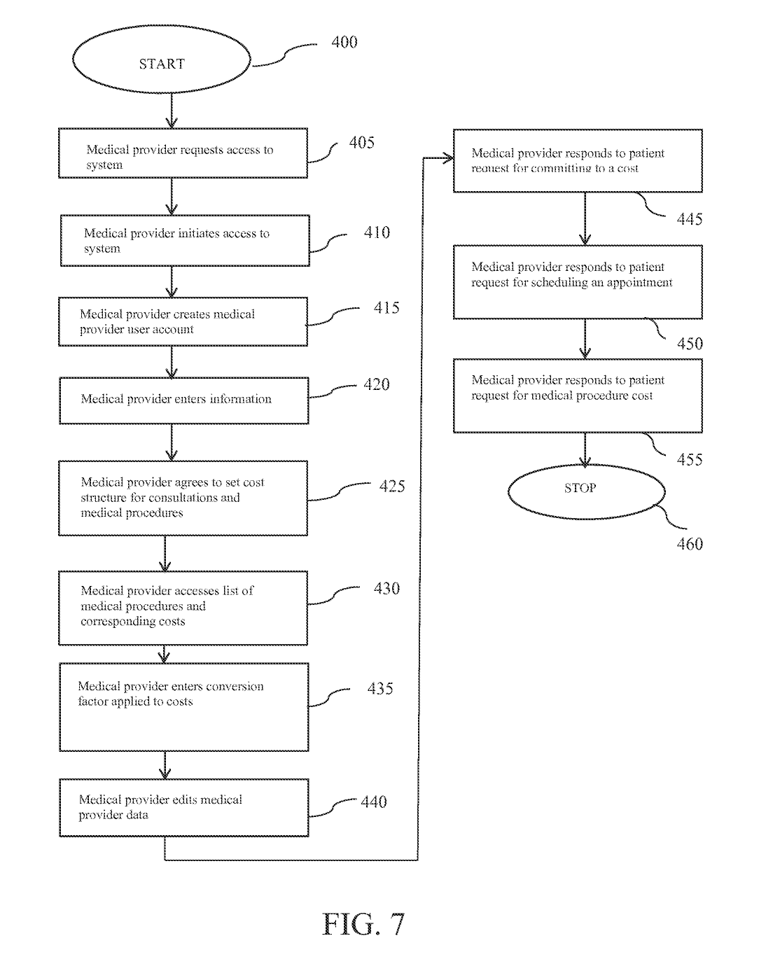

Referring now to FIG. 7, a method for a medical provider to use the system 10 will now be described. The medical provider process starts at step 400. A medical provider requests access to the system 10 (step 405) or alternatively may be invited to provide medical provider information to the system 10. A medical provider initiates access to the system 10 through the MPII 45 (step 410) and creates a medical provider user account (step 415) for which the medical provider may be required to agree to terms and conditions of the system 10. The medical provider enters medical provider information through the MPII 45 that is stored in the database 25 as part of the medical provider data associated with the medical provider profile (step 420). The medical provider also agrees to a set cost structure for consultations and medical procedures through the MPII 45 (step 425). To verify costs assigned in the system 10, the medical provider may access the list of medical procedures and the corresponding costs assigned by the RVS through the MPII 45 (step 430). In one embodiment, this may be done by the medical provider requesting the cost that the RVS has assigned to a specific medical procedure by entering a CPT code for the medical procedure through the MPII 45. The medical provider may also enter a conversion factor that is applied to the cost assigned in the RVS through the MPII 45 (step 435), such that the RVS modified by the entered conversion factor provides the costs for which the medical provider agrees to conduct consultations and perform medical procedures. The medical provider may later edit her medical provider information through the MPII 45 to keep her practice and cost information current (step 440). In one embodiment, the medical provider may respond to a request from a patient inquiring whether the medical provider can commit to costs for a consultation and/or a medical procedure, wherein the medical responds to the request through the MPII 45 (step 445). In another embodiment, the medical provider may respond to a request from a patient to schedule an appointment with a patient for a consultation and/or a medical procedure to be performed (step 450). When the medical provider meets with the patient, the medical provider may also provide cost information to the patient for medical procedures that the medical provider recommends to be performed based on the RVS and any conversion factor submitted by the medical provider (step 455). The process ends at step 460.

Although particular embodiments of the present inventions have been shown and described, it will be understood that it is not intended to limit the present inventions to the preferred embodiments, and it will be obvious to those skilled in the art that various changes and modifications may be made without departing from the spirit and scope of the present inventions. Thus, the present inventions are intended to cover alternatives, modifications, and equivalents, which may be included within the spirit and scope of the present inventions as defined by the claims.

What is claimed is:

1. A system providing for medical provider information to a patient, comprising:
a patient input interface configured to be presented on an electronic display, comprising preference categories from which a patient selects preference criteria for a potential medical provider;
a database comprising a list of medical providers and medical provider data for each of the medical providers, wherein the medical provider data comprises medical provider information corresponding to the preference criteria;
a processor configured to communicate with the patient input interface and with the database to compare the preference criteria of the patient with the medical provider data and to generate a results list of potential medical providers with medical provider information matching the preference criteria of the patient; and
a results display configured to be presented on the patient input interface that displays the results list of potential medical providers and a cost of a consultation for each of the potential medical providers.

2. The system of claim 1, wherein the preference categories comprise one or more of location, language spoken, board certification status, medical specialty, and gender.

3. The system of claim 1, wherein the medical provider data further comprises the cost of a consultation.

4. The system of claim 1, wherein the processor is configured to send a request for the cost of a consultation to each of the potential medical providers and is further configured to receive the cost of a patient consultation from each of the potential medical providers.

5. The system of claim 1, wherein the patient input interface is further configured to request a patient to create a patient user account.

6. The system of claim 1, wherein the patient input interface is further configured to receive a request from a patient to schedule an appointment with one of the potential medical providers.

7. A system for storing and displaying medical procedure costs, comprising:
a database stored on a server comprising,
a list of medical procedures,
a list of medical providers associated with the list of medical procedures in a manner that identifies each of the medical providers that performs each of the medical procedures, and
a fixed cost for each identified medical provider to perform each of the respective medical procedures;
an interface configured to receive a request for the fixed cost for at least one of the identified medical providers to perform at least one of the respective medical procedures; and
a processor that communicates with the interface and is configured to process the request for the fixed cost and to communicate with the database to obtain data responsive to the request for the fixed cost, and is further configured to communicate the data to the interface for display on the interface.

8. The system of claim 7, wherein the database further comprises a Relative Value Scale that assigns a cost to each of the medical procedures in the list of medical procedures.

9. The system of claim 8, wherein the fixed cost for each identified medical provider to perform each of the respective medical procedures is based on the Relative Value Scale.

10. The system of claim 8, wherein the fixed cost for each identified medical provider to perform each of the respective medical procedures is based on the Relative Value Scale in combination with one or more conversion factors.

11. The system of claim 10, wherein the one or more conversion factors is applied to each cost assigned by the Relative Value Scale.

12. The system of claim 10, wherein the interface is configured to receive the conversion factor for each medical provider in the list of medical providers, and each conversion factor is stored in the database in association with the respective medical provider.

13. The system of claim 8, wherein the interface is further configured to receive a request for the cost assigned by the Relative Value Scale to one or more medical procedures in the list of medical procedures.

14. The system of claim 7, wherein each medical procedure in the list of medical procedures has a corresponding code stored in the database by which the respective medical procedure is identified.

15. The system of claim 7, wherein the interface is further configured to receive the request for the fixed cost from one of the at least one of the identified medical providers.

16. The system of claim 7, wherein the list of medical procedures includes consultations.

17. A method for a patient to obtain information relating to one or more potential medical providers, comprising:
accessing a system comprising a list of medical providers each having corresponding medical provider data;
receiving preference categories from the system from which to select preference criteria for a medical provider;
submitting a request to the system for medical providers that match the preference criteria; and
receiving a results display from the system that features a results list comprising potential medical providers from the list of medical providers, wherein the preference criteria at least partially matches the corresponding medical provider data for each of the respective medical providers.

18. The method of claim 17, wherein the results display shows the cost of a consultation for each of the potential medical providers.

19. The method of claim 17, further comprising storing the results list through a patient user account associated with the system.

20. The method of claim 17, further comprising submitting a price range to the system for a consultation with a medical provider, and submitting a request to identify medical providers from the list of medical providers who charge a price within the price range for a consultation.
